(19) United States
(12) Patent Application Publication
(10) Pub. No.: US 2007/0172621 A1
(43) Pub. Date: Jul. 26, 2007

(54) Pre-printed sticky notes and methods of use to send messages or expressions, decorate, provide interactive learning or playing environments, and for scrapbook and calendar uses

(76) Inventor: Cynthia Sue Haske Wittke, Wausau, WI (US)

Correspondence Address: ERIC HANSCOM, 7395 PORTAGE WAY, CARLSBAD, CA, 92011, US

(21) Appl. No.: 11/648,736

(22) Filed: Jan. 3, 2007

Related U.S. Application Data
(60) Provisional application No. 60/761,141, filed on Jan. 23, 2006.

(51) Int. Cl. B32B 33/00

(52) U.S. Cl. 428/40.1; 283/81

(57) ABSTRACT

This invention is directed toward packs, pads, sheets or rolls of repositionable and reusable sticky notes that are pre-printed with one or more themes, thereby enabling a user of the invention to decorate a home, office, or other structure with the sticky notes to convey a message or expression. The sticky notes are complied in the traditional fashion, with each note having a portion near the top, side, center or bottom or all over if on a roll or sheet which has removable, semi-sticky glue which allows it to stick to a wall. Because the sticky notes are easily removed from the pack, and are pre-printed with the desired message, they are easily placed in large or small quantities on a mirror, wall, floor, ceiling, car, seat, file folder, scrapbook or other hard or soft surface in a decorative manner to send a bold message.

### CROSS REFERENCE TO RELATED APPLICATIONS

This application claims benefit of Provisional Application No. 60/761,141, filed on Jan. 23, 2006, a copy of which is attached to this Utility Patent Application and incorporated by reference.

### STATEMENT REGARDING FEDERALLY SPONSORED RESEARCH OR DEVELOPMENT

This invention was not federally sponsored.

### BACKGROUND OF THE INVENTION

This invention is directed toward packs, pads, rolls, or sheets, of sticky notes that are pre-printed with one or more themes, thereby enabling a user of the invention to decorate a home, office, or other structure or object with the sticky notes to convey a message or expression, such as “Happy Birthday”, “Congratulations”, “Get Well,” “Happy Holidays,” “Thank You,” etc, pictures, numbers, symbols, etc.

The sticky notes are compiled in the traditional fashion, with each note having a thin portion near the top, side or sides, center or bottom, or all over if on a roll or sheet, which has a removable, semi-sticky glue which allows it to stick to a wall or other object (or to the note directly behind it in the pack), but also allows a user to remove it without removing paint from the wall or leaving behind any undesirable glue residue. Because the notes are all printed with messages, a user of the invention can easily and rapidly place one, some or many such notes on the wall or object so as to decorate it, thereby sending a “loud” message or expression to the intended recipient. The user can also use a single sticky note, or larger amounts of the pre-printed sticky notes, to convey a message in a greeting card, letter, scrapbook, photo album, etc.

The history of sticky notes goes back to 1974, when 3M engineer Art Fry invented the Post-It Note. Fry combined an adhesive invented years earlier by another engineer at 3M with a standard piece of paper, in a shape and size useful for being a note. The adhesive, invented by a 3M chemist named Spencer Silver was a mixture of some simple organic molecules which, when combined in a manner which remains a trade secret, produced an adhesive described as “inherently tacky elastomeric copolymer microspheres”, which, in plain English, means that the adhesive had an irregular surface texture with peaks and valleys, somewhat resembling the surface of a basketball. While the peaks stuck to whatever they came into contact with, the valleys prevented a complete seal, allowing it to stick fairly well, but not very strongly, thereby allowing for it to be removed. Fry then added a primer to the paper which caused the adhesive to stick more firmly to the paper than to the wall or other object to which the note was affixed, thereby creating the commercially successful Post-It Note that has become as much a mainstay of the average office as staplers and paperclips.

Once 3M's patent on the Post-It® Note expired, numerous competitors began producing similar products, to the point where presently there are a number of companies producing sticky notes of all shapes, colors, and sizes. These products, however, still require a user of them to write a message on the sticky note before using the note to convey a message. For example, in a patent office setting, it would be convenient for a person reviewing a patent application to be able to take sticky notes with messages such a “103 problem”, “Re-write this section”, “Are you sure there is no prior art on this aspect?”, from a stack of sticky notes and affix the proper note on the application. As another example, a secretary sorting mail away from the mailboxes in an office could affix sticky notes with various employees' names, and messages such as “Greg” “bill”, Important!”, “Payment” on each piece of mail.

The inventor has also determined that placing sticky notes with pre-printed messages on a mirror or wall is an effective, and easily removed, method of sending a message. Since prior to this invention, a user needs to write a message on each sticky note, it would be very time consuming for a user to prepare enough sticky notes to use the sticky notes in large quantities to loudly proclaim a message, expression, or celebration, or to decorate (albeit probably temporarily) a room, office, etc. Because the sticky notes lend themselves so readily to being stuck on a wall quickly and removably, the inventor has discovered that a large number of these sticky notes placed on a wall or mirror makes a very effective means of conveying a message, expression or celebration.

Thus there has existed a long-felt need for packs of sticky notes with pre-printed messages on them, which can be used for both quickly attaching a message to an item and decorating a wall or other structure with the desired message or expression.

The prior art has a number of inventions that sticky notes in various configurations. Obviously, the sticky note itself is well known in the art, but a substantial number of variations on that basic theme have been proposed. For example, U.S. Pat. No. 5,332,265 to Groess, et. al., teaches an advertising assembly which uses a plurality of advertising indicia arranged on an insert or as a trade show handout. U.S. Pat. No. 6,526,906 to Bidanset, et. al., and US Patent Application No. 2003/0178840 to Bidanset, et. al, teach a page marking device with removable tabs which can be affixed to an advertisement for a certain type of gift. US Patent Application No. 2005/0110267 to Stewart, et. al., provides a bookmark with a plurality of self-stick notes attached thereto.

There also exist a number of inventions dealing with methods of making various types of sticky notes. For example, U.S. Pat. No. 6,268,032 to Mertens, et. al., which describes a web sheet of material, whereas U.S. Pat. No. 6,773,539 to Mertens, et. al., provides a method for cutting sticky notes from a roll of starting material. U.S. Pat. No. 5,782,494 to Crandall allows a user of a basic personal computer to make his or her own sticky notes.

Another invention is described by U.S. Pat. No. 6,379,764 to Pusateri, et. al., which teaches a method and apparatus for securing a sticky note onto an advertisement. Finally, U.S. Pat. No. 5,705,244 to Lee covers a composite note pad assembly.

While these inventions all provide improvements to the existing technology, none of them teach the idea of mass-produced sticky notes with a certain message, expression or celebration, nor do these patents and applications describe a manner of using the message-containing sticky notes for use in efficiently designating or categorizing items by the individual messages contained on the pad of sticky notes. Additionally, there is no hint of the use of any of these sticky notes and close approximations thereof for temporarily decorating a mirror or wall, object, scrapbook, photo album, etc. as a means of decorating, celebrating or communicating.

The idea of a sticky note with pre-printed indicia is also known. For example, 3M offers a number of sticky notes with pre-printed logos. However, the examples found in the prior art search date from after the date of applicant's provisional patent, and also supply only identifying information such as a name or “From the Desk of ______”. The prior art does not disclose a sticky note with a pre-printed message—as opposed to identifying information—which would allow a user to quickly affix a sticky note with the proper message to an item. The prior art also does not teach a sticky note with a message proper for decorating a wall or other structure with many such sticky notes, nor do the sellers of any of the pre-printed sticky notes suggest the use of their sticky notes in mass quantities as a decorative means to send a message, expression or celebration.

The current invention provides just such a solution by having a pre-printed pack of sticky notes with one or more themes printed on each sticky note, thereby enabling a user of the invention to decorate a home, office, or other structure with the sticky notes to convey a message or expression, such as “Happy Birthday”, “Congratulations”, “Get Well,” “Thank You” & “Happy Holidays,” etc. The sticky notes are compiled in the traditional fashion, with each note having a thin portion near the top, side, center or bottom or all over if on a roll or sheet, which has a removable, semi-sticky glue which allows it to stick to a wall or other object, (or to the note directly behind it in the pack), but also allows a user to remove it without removing paint from the wall or other object or leaving behind any undesirable glue residue. Because the sticky notes are easily removed from the pack, and are pre-printed with the desired message, they are easily (easy) to place in large or small quantities on a mirror or wall (or even a floor, ceiling, car, seat, scrapbook, photo album or other hard or soft surface) in a decorative manner to send a forceful (bold) message. Thus, the inventor has invented not only a new product but also a new way of using sticky notes to send a message in a manner not seen to date.

### SUMMARY OF THE INVENTION

It is a principal object of the invention to provide a sticky note with a pre-printed message, expression or celebration.

It is another object of the invention to provide packs, pads or sheets, of sticky notes with pre-printed messages on them where the packs can be of different designs, shapes, sizes, scents and colors, and there can be a wide variety of messages.

It is an additional object of the invention that the packs of sticky notes can have either one message in one or more colors and/or designs, and a variety of “themed” messages in one or more colors and/or designs.

It is a further object of the invention that the sticky notes can be quickly and easily removed from the pack and adhered to a wall, desk, table, chair, mirror, seat, car, scrapbook, card, letter or other hard or soft object including people and pets.

It is also an object of this invention that a user of the invention can decorate a desired surface with the notes quickly, easily, and in an eye-pleasing manner, such that the notes can be easily and cleanly removed once the user of the invention wishes to remove the notes.

It is a final object of this invention that the use of pre-printed sticky notes can save a user time in sending a frequently-sent message, and allows him/her to use large or small quantities of sticky notes to send a bold message by affixing the large or small quantities of sticky notes to the desired surface.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### DETAILED DESCRIPTION OF THE INVENTION

The invention involved pre-printing sticky notes and assembling them into packs, pads, rolls or sheets. To produce the invention, it is necessary to print the desired message on a piece of paper of the desired color and in the desired size. A primer is laid on the paper which is intended to be “sticky”, after which the adhesive is laid over the primer. Groups of sticky notes are then compiled into stacks, sheets, rolls, or pads. While the chemical composition and method of adhesion remains trade secrets, the general principle is well known and practiced by a substantial number of companies in the tape and general office supply fields. Thus, the process is mentioned not as a part of the actual invention but rather to illustrate how a company already in the field of sticky notes could begin producing the invention.

The advantages of this invention are detailed above in the Summary of the Invention. Basically, the invention consists of a pre-printed pack of sticky notes with one more themes printed on each sticky note, thereby enabling a user of the invention to decorate a home, office, or other structure or object, person or animal with the sticky notes to convey a message or expression, such as “Happy Birthday”, “Congratulations”, “Get Well,” “Thank You,” “Happy Holidays,” etc. The sticky notes are compiled in the traditional fashion, with each note having a thin portion near the top, side or sides, center or bottom or all over if on a roll or sheet, which has a removable, semi-sticky glue which allows it to stick to a wall or object (or to the note directly behind it in the pack), but also allows a user to remove it without removing paint from the wall or object or leaving behind any undesirable glue residue or to most surfaces. Because the sticky notes are easily removed from the pack, and are pre-printed with the desired message, they are easily (easy) to place in large or small quantities on a mirror or wall (or even a floor, ceiling, car seat, scrapbook or other hard or soft surface) in a decorative manner to send a forceful (bold) message. Thus, the inventor has invented not only a new product but also a new way of using sticky notes to send a message in a manner not seen to date.

The printed material on the face of the sticky notes can range to include words, expressions, pictures, famous sayings, quotes, verses, common phrases, numbers, letters of exclamations, celebration, inspiration, encouragement or other statements printed on each sheet. The sticky notes can also be customized in terms of having a texture added to the surface, being made in a specific color, or with an item of artwork ordered or created by the customer who orders the sticky notes. There are two main purposes of the invention. First, there are frequently sent messages, whereby a user of the invention would merely need to affix the proper sticky note in the proper location. For example, a professional reviewing the work of an assistant could slap sticky notes with sayings such as “Yes”, “No”, “See Me”, “Send to Typing”, or “Greg” on the file rather then writing it by hand. While the savings in time on an individual case would be small, the cumulative savings of time over the course of a year would be substantial. The second and preferred iteration of the invention would be to use large or small quantities of sticky notes with messages pre-printed on them to decorate the home, office, school, transportation, etc. as a means of expression, communication, celebration, encouragement, education or entertainment.

It is also envisioned that a variety of colors, shapes, scents, designs, embellishments, (glitter, glow in the dark, etc.) and messages could be incorporated into the notes such that a user of the invention could create a wide range of responses. Among the locations at which these notes could be used are homes, businesses, offices, classrooms, lockers, hospital rooms, wedding locations, bridal and baby showers, scrapbooks (photo albums), greeting cards, letters, parties & events of all sorts, in cars, on bicycles, on people, pets, etc.

There are several specific uses of the notes that are contemplated in addition to the uses described heretofore. For example, a travel pack of notes could describe or have pictures of objects commonly seen while riding in a car or bus, such as stop signs, railroad crossing signals, trains, motorcycles, etc., and could be used to educate or entertain children (as making a game of it) during the trip. A color pack with the color and name printed on it could allow a parent to teach a child about colors, allowing the child to find an object of a specific color and stick on the appropriate sticky note to that object (and learn to spell the name of the color at the same time).

Other educational packs of notes could include names of household objects, where a sheet could be given to the child and he/she must stick the sheet on the correct item. A multi-lingual household pack could have the names of household objects or everyday phrases in various languages.

Another specific use would be a pack of 365 (plus extra for leap years) sticky notes where each successive sticky note in the pack of 365 sticky notes has an ascending number to signify the day of the year a user of the invention is currently living and would also include a space upon which a user of the invention could write down things specific to that day, such that a user of the invention could compile a year's worth of sticky notes and store them as a journal of that year or place individual sticky notes in a scrapbook or other type of memorabilia. This way, a user of the invention could keep the sticky note which corresponded to a particularly important day. A further iteration of this invention would have successive sticky note additionally comprising one or more sections, where each section had a heading indicating the type of thing that should be written in the section, such as “Things I Did Today”, “Special Event of the Day”, “Lesson for the Day”, “Rate the Day or Value of the Day” or a similar type of heading. An additional option would be to have each pack of 365 sticky notes be identified as relating to a particular year of a person's life—such as year 20, and where each pack of 365 sticky notes would have a first sticky note, and the first sticky note would be numbered the day of a person's life corresponding to the particular year of a person's life In the example of a pack of sticky notes for a person is his/her 20^{th} year of life, a person celebrating their 20^{th} birthday would be living his or her 7305^{th} day of life (adding in the leap year days). The number on the first page of the pack would be 7306, the second page=7307, third page 7308, etc. It would be somewhat like a Calendar of the year but would not reference an actual date. The user could stick the sticky note to anything for the day as a reminder of something to do or as a remembrance of the day and place it in a card, scrap book, photo album, mirror, etc.

A set of notes for a wedding could include color-coded seating designations. Notes with various messages could also be used for ice-breakers and introductions: A person planning a party could give the attendees various pre-printed sticky notes which are either color coded or state the interests, background, etc. of the various attendees. These sticky notes could be a great way to “break the ice” and make introductions.

What I claim is:

1. A device for sending messages or expressions to people using repositionable and reusable sticky notes, comprising: a plurality of sticky notes which has printed on each a single pre-printed message compiled into a pack of sticky notes, where, the message is selected from the group comprising a personal message, expression, or directive for action.

2. The device of claim 1, where each sticky note consists of a piece of paper with semi-sticky glue covering the entire back of the sticky note with the exception of a thin border on the top, bottom, and sides of the sticky note.

3. The device of claim 1, where each sticky note consists of a piece of paper with semi-sticky glue covering the entire back of the sticky note.

4. The device of claim 1, where the message consists of a word or words not related to the identity of a person or of a company.

5. The device of claim 1, where the message consists of a personalized name of a specific person.

6. The device of claim 1, where, the sticky notes additionally comprise a specific color

7. The device of claim 1, where, the sticky notes additionally comprise a specific item of artwork, where the specific item of artwork is customized by the maker of the sticky notes according to directions given by a customer ordering the sticky notes.

8. The device of claim 1, where, the sticky notes additionally comprise a specific texture.

9. The device of claim 1, where, the sticky notes additionally comprise a specific scent.

10. The device of claim 1, where, the sticky notes additionally comprise a specific shape.

11. The device of claim 1, where, the sticky notes additionally comprise a Braille message which comprises one or more raised dots on the surface of the sticky notes.

12. The device of claim 1, where the sticky notes consist of a pack of 365 (plus extra for leap years) sticky notes where each successive sticky note in the pack of 365 sticky notes has an ascending number to signify the day of the year a user of the invention is currently living and would also include a space upon which a user of the invention could write down things specific to that day, such that a user of the invention could compile a year's worth of sticky notes and store them as a journal of that year or place individual sticky notes in a scrapbook or other type of memorabilia.

13. The device of claim 12, where each successive sticky note additionally comprises one or more sections, where each section has a heading indicating the type of thing that should be written in the section, such as “Things I Did Today”, “Special Event of the Day”, “Lesson for the Day”, “Rate the Day or Value of the Day” or a similar type of heading.

14. The device of claim 12, where each pack of 365 (plus extra for leap years) sticky notes would be identified as relating to a particular year of a person's life—such as year 20, and where each pack of 365 sticky notes would have a first sticky note, and the first sticky note would be numbered the day of a person's life corresponding to the particular year of a person's life.

15. A means of conveying a message to a recipient, where the message can be conveyed quickly and the means of conveying the message can be easily and conveniently cleaned up and removed once the message has been conveyed, comprising the steps of: first, obtaining a plurality of sticky notes which has printed on each a single pre-printed message compiled into a pack of sticky notes, where, the message consists of a word or words not related to the identity (other than boy, girl, friend, bride, groom, etc.) of a person or of a company, but rather consists of a personal message or directive for action, second, positioning a plurality of the sticky notes on a surface such as a mirror or wall, and, third, after the message has been sent, the ability of removing the plurality of sticky notes from the surface onto which they had been applied. These notes can be repositioned/replaced easily and could most likely be re-used.

16. The means of conveying a message of claim 15, where the surface is located in an professional environment, such as an office, hospital, business, or other professional environment, and the message consists of a communication related to the personal life, for example, “Happy Birthday”, or employment, for example, “Congratulations on the Promotion”, of the recipient of the message.

17. The means of conveying a message of claim 15, where the surface is located in a home environment and the message consists of a communication related to the personal life, for example, “Happy Birthday”, “Will You Marry Me?” of the recipient of the message.

18. The means of conveying a message of claim 13, where the surface is a mirror, for example, “I Love You!”

19. The means of conveying a message of claim 15, where the message is produced in a certain color and relates to a seating arrangement at a social function, such as a wedding.

20. The means of conveying a message of claim 15, where there are several different note packs used to organize a seating arrangement and where each color relates to a certain characteristic of the people to be seated, such as whether wedding attendees are part of the wedding party, bride's friends or groom's friends.

21. A means of performing an educational, entertaining or gaming function through use of a plurality of sticky notes, where each sticky notes has printed on it a different pre-printed message compiled into a pack of sticky notes, where, the messages consists of a word or words not related to the identity of a person or of a company, but rather consists of a noun, verb, or directive for action, comprising the steps of: first, a plurality of sticky notes where each sticky notes has printed on it a different pre-printed message compiled into a pack of sticky notes, where, the messages consists of a word or words not related to the identity of a person or of a company, but rather consists of a noun, verb, or directive for action, second, educational utilization of the sticky notes to teach a subject, and, third, after the message has been sent, removing the plurality of sticky notes from the surface onto which they had been applied.

22. The means of performing an educational or entertaining function of claim 21, where the subject is a foreign language and the messages consist of the identities of a particular household or office object, such as a toaster or computer monitor, in one or more languages, and the educational utilization consists of having a person peel off individual sticky notes and attach each to the appropriate object as identified on the sticky note.

23. The means of performing an educational or entertaining function of claim 21, where the subject is the proper words for various objects seen during a period of transportation, such as a long drive, bus ride, or train ride, and the messages consist of the identities of objects commonly seen during such periods of transportation, such as stop signs, railroad crossing, and police cars, and the educational or entertaining utilization consists of having a child peel off the proper individual sticky note when he/she sees a particular object which is described on an individual sticky note, and place the proper individual sticky note on a predetermined surface, such as the back of the front seat of a car.
